(19) United States
(12) Patent Application Publication
(10) Pub. No.: US 2018/0194158 A1
(43) Pub. Date: Jul. 12, 2018

(54) SECURITY DOCUMENT WITH TRANSPARENT WINDOW

(71) Applicant: ASSA ABLOY AB, Stockholm (SE)

(72) Inventors: Stephane AYALA, Oron-la-Ville (CH); Allan MALCOLM, Kuala Lumpur (MY); Steve Yi-Li TIEN, Roehrmoos (DE)

(21) Appl. No.: 15/741,922

(22) PCT Filed: Mar. 29, 2016
(86) PCT No.: PCT/IB2016/051772

§ 371 Date: Jan. 4, 2018

(30) Foreign Application Priority Data
Jul. 9, 2015 (CH) 00997/15

(51) Int. Cl. B42D 25/351; G06K 19/077

(52) U.S. Cl. CPC B42D 25/351; G06K 19/07722; G06K 19/07773

(57) ABSTRACT

The present invention relates to a security document comprising at least an antenna and a chip connected to the antenna. The security document is characterised in that it further comprises at least one transparent window arranged such that at least a part of said antenna is visible in said window thereby forming a visible security feature.

### TECHNICAL FIELD

The present invention concerns the field of electronic security documents, such as electronic passport inlays, smart cards or security credentials, that have an RFID functionality, with an antenna and a chip or chip module connected to said antenna, whereby said devices comprise a security feature to facilitate identification and authentication of the device.

More specifically, the present invention concerns such document that comprises an element in the form of a transparent window that allows at the same time to provide a security and differentiating feature of the said document. The present invention provides a transparent window forming an enhanced visible security feature for the device.

### BACKGROUND OF THE INVENTION

FIGS. 1 to 3 illustrate a known security document 1 comprising a transparent window 2 as security feature.

The security document 1 includes a document body comprising a transparent window 2 comprising a personalised element 3 such as a photo or an image of the owner or user of the security document 1. The element 3 is then visible from both sides of the security document.

As seen in FIG. 3, the security document 1 further includes, on one of its internal layers 11, an antenna 18 connected to a chip 17 permitting RFID functionality.

However, a weakness of this security document is that a transparent window alone is not a guarantee against forgery. In particular, a blank transparent window 2 can be fraudulently personalised or modified to include an image or photo of any person. Such known security documents thus include this security weakness.

### SUMMARY OF THE INVENTION

The present invention addresses the above mentioned problem and provides a security document that is difficult to fraudulently copy.

The present invention concerns a security document comprising a security element in the form of a transparent window that simultaneously provides a security and differentiating feature of said document that is difficult to counterfeit or forge.

The present invention involves forming a visible security feature in a transparent window that is difficult to counterfeit or forge and that can be uniquely personalised.

The present invention in particular relates to a security document according to claim 1, Further advantages of the present invention are provided by the features of the dependent claims.

In particular, the present invention advantageously includes a security feature or element including at least one partially or fully transparent window as well as at least a portion of an antenna of the security document, said portion of the antenna being present in the at least one partially or fully transparent window and being partially or fully visible in said window.

The antenna design or layout defines a visible security marking or characteristic in the window. For example, a word or a logo is defined or created inside the window by the antenna portion. In the case where the window is personalized with a user image for example, the antenna portion can for instance define a framing around the user image.

Moreover, the design or layout of the antenna can be used as background artwork overlapping, for example, with fine lines produced by laser engraving to create a visual effect.

The antenna portion layout as well as the above mentioned combination provides a unique personalized security feature. Advantageously, this antenna path layout customization can be done project by project, customer by customer in order to provide a unique security feature that facilitates the authentication of the security document and/or identification of the security document user.

Advantageously, the security document of the present invention is difficult to fraudulently copy because any such copying necessitates reproducing a security marking having a particular antenna design or layout and such reproduction requires access to advanced technical capabilities for handling and manipulating antennas for RFID functionality.

### BRIEF DESCRIPTION OF THE DRAWINGS

The above object, features and other advantages of the present invention will be best understood from the following detailed description in conjunction with the accompanying drawings, in which:

FIGS. 1 to 2 show a known security document;

FIGS. 3 shows details of the structure of a known security document but that can also for example be used for producing a security document according to the present invention as explained further in detail below;

FIG. 4 illustrates an RFID inlay or internal sheet according to an embodiment of the present invention;

FIG. 5 illustrates an RFID inlay or internal sheet according to another embodiment of the present invention;

FIG. 6 illustrates an RFID inlay or internal sheet according to yet another embodiment of the present invention;

FIG. 7 illustrates a security document according to one exemplary embodiment of the present invention;

FIG. 8 illustrates a security document according to one exemplary embodiment of the present invention;

FIG. 9 illustrates yet another a security document according to an exemplary embodiment of the present invention; and

FIG. 10 illustrates another security document according to an exemplary embodiment of the present invention.

### DETAILED DESCRIPTION OF THE INVENTION

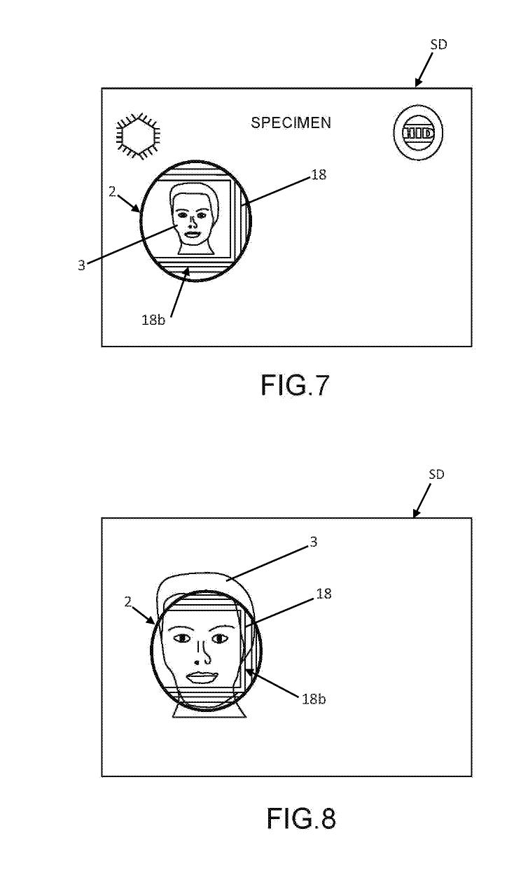

The present invention concerns a security document 1. FIGS. 7 and 8 show a exemplary security document 1 according to the present invention.

The security document 1 can be, for example, a passport, an electronic passport inlay, a smart card, a security credential, an identification card, an access card, a driver's licence, a bank card or a security object for identification and/or authentication containing data such as personal or professional data.

The security document 1 includes a transparent window 2, which corresponds to a cavity extending through the entire body of the security document and filled with a fully or partially transparent material. That is, a fully clear or partially clear window through which one can see through from one side of the security document to the opposite side of the security document 1.

In other words, the document includes a transparent tunnel passing from a first side of the document through the document to a second side of the document permitting to see through the document from one side of the document to the other side when looking in the transparent window. The transparent window defines an opening of the transparent tunnel.

The document is preferably opaque except at a section of the document defined by the transparent window. The transparent window occupies a limited portion of the surface area of the document. The transparent window occupies for example a surface area of the document comprised between 1% and 50% of the total document surface area, and preferably occupies a surface area of the document comprised between 1% and 15% of the total document surface area.

The security document 1 further includes an antenna 18 for RFID functionality and a chip or chip module 17 permitting RFID functionality.

The ends of the antenna 18 are connected to terminals of the chip 17. The antenna 18 is configured to receive an electromagnetic wave transporting chip operational energy and/or data for the chip 17, and to provide this to the chip 17. The antenna 18 in association with the chip 17 also transmits an electromagnetic wave for external data transmission of data provided by the chip 17. The chip 17 is configured to carry out RFID functionality in association with the antenna 18.

An exemplary method for producing a security document 1 with a transparent window 2 according to the present invention with reference to a known method is now described with reference to details of its structure as illustrated in FIG. 3. This example is not limitative and there exists many other possible ways known to a skilled person to create a security document with a transparent window according to the present invention and many resulting structures for a security document with a transparent window.

In this exemplary method, an RFID inlay or substrate 11 is firstly provided. This substrate 11 is for example a (partially or fully) transparent pre-laminate sheet upon which the antenna 18 is provided or laid out.

The antenna 18 is preferably formed by wire embedding on the substrate 11.

In another preferred embodiment, the antenna is printed on the substrate 11 (for ex. by screen printing). Advantageously, this also permits the antenna portion (which is going to be visible in the transparent window) to be formed in different colours to further render the security document more difficult to forge.

Alternatively, the antenna may be formed on the internal sheet 11 via etching and metal deposition.

The antenna can be configured to operate at LF (Low Frequency: 20-200 kHz), HF (High Frequency: 3-30 MHz) or UHF (Ultra-High Frequency: over 300 MHz). A LF or HF has the form of a coil antenna with multiple windings. The UHF antenna can be for example a patch antenna, a slot antenna or a dipole antenna.

The substrate 11 further supports the RFD chip or chip module 17 which is connected to the antenna 18 by flip-chip, thermal bonding or any known method of the art.

A first covering layer 12 is positioned below the substrate 11 (see FIG. 3) and a second covering layer 12′ is positioned below the substrate 11.

Like the substrate 11, the first and second covering layers 12, 12′ are preferably made of transparent (or partially transparent) material, but on which a printed coating has been applied. The printed coating is opaque and is applied on almost the entire surface of the covering layers 12 and 12′, except on a zone 15 and zone 15′ respectively defining the transparent window of the first and second covering layers 12, 12′. Alternatively, the first and second covering layers 12, 12′ are non-transparent layers including an opening where a portion of the layer is replaced by a transparent material to define a transparent window.

The position of the zones 15 and 15′ respectively on the first and second covering layers 12 and 12′ is identical such than when both layers are collocated, both transparent zones 15, 15′ lay exactly one on the other. That is, the window 15 of the first covering layer 12 is situated directly above and directly over the window 15′ of the second covering layer 12′. The windows overlap so that one can see from the side of the first covering layer 12 through to the opposite side where the second covering layer 12′ is located, and vice versa.

Finally, a transparent protective overlay 13 and 13′ is respectively on the external side of the first covering layer 12 and the second covering layer 12′ to form the security document 1.

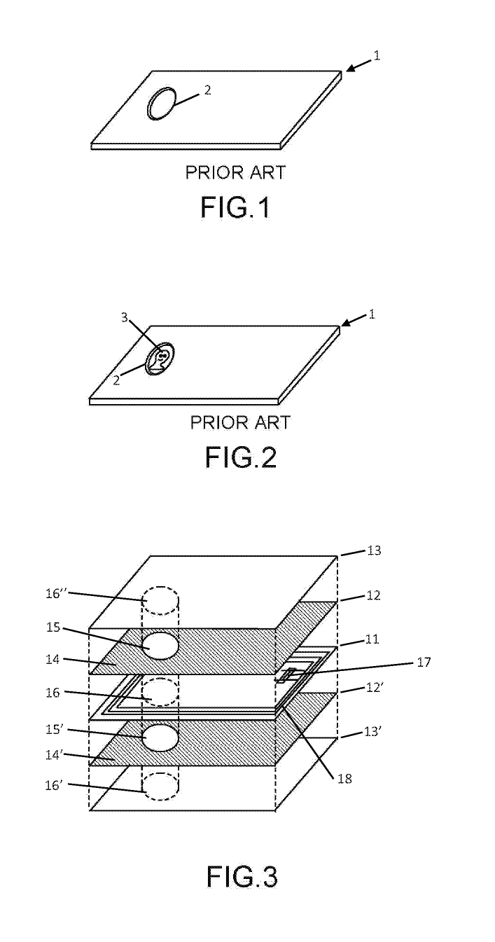

All layers 11, 12, 12′, 13 and 13′ are collocated as shown in FIG. 3 and are bound together, for example, by lamination, thermal bonding, gluing or ultra-sonic bonding, forming a security document 1 showing a transparent window 2 as for example shown in FIG. 1. The position of the transparent window is uniquely defined by the position and extent of the zone 15 and 15′ of layers 12 and 12′ to which a non-opaque coating has been applied.

Corresponding zones 16, 16′ and 16″ respectively of the layers 11, 13 and 13′ marked by dotted or dashed lines in FIG. 3 are part of the transparent window 2 because they are the portions of their respective layers which are located at the vertical of the zones 15 and 15′, that is located above or below zones 15 and 15′ of layers 12 and 12′ respectively. The corresponding zones 16, 16′ and resp. 16″ define the passage of the transparent tunnel through the document.

The above mentioned additional security feature 3 can be formed on the window of the first and/or second covering layers 12, 12′ using, for example, laser engraving, Such personalization by laser engraving has the advantage to be applied on the finished document i.e. through the transparent protective overlay 13 or 13′. Such direct printing should either be applied before lamination of the layers, or on the external surface of the protective overlays 13 or 13′.

As will be discussed further, and according to the main embodiment of the invention, the position of non-coated zones 15 and 15′ on the layers 12 and 12′ can be chosen so that a portion of the antenna 18 is located partially or fully inside the window when the layers are collocated and laminated, defining a visual security feature visible inside of the transparent window 2.

Compared to the document illustrated in FIG. 3, the transparent window and tunnel is positioned relative to a portion of the antenna to include the portion of the antenna inside the transparent window and tunnel and the portion of the antenna is visible in the transparent window and tunnel.

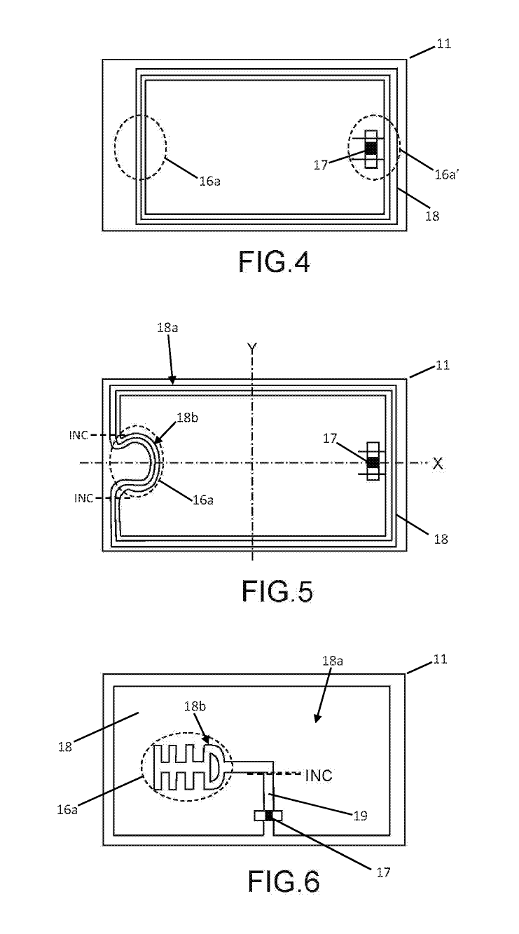

According to the present invention, the substrate 11 is for example any one of the substrates illustrated in FIGS. 4 to 6.

According the general concept of the invention, the transparent window 2 includes at least a portion of the antenna 18. The portion of the antenna 18 is present in the window and is partially or fully visible in the window. In the regions of the window where the antenna portion is not present one can, for example, see through from one side of the security document SD to the opposite side of the security document SD of the present invention.

This portion of the antenna is thus a visual security feature of the security document SD. The portion of the antenna advantageously and simultaneously fulfils the role of a visual security feature as well as an RFID functionality.

In a first embodiment of the invention, the transparent window 2 includes a portion of an antenna loop or winding(s) running round, for example, the perimeter of the security document SD. This portion of the antenna loop or winding(s) is located in the window 2 and defines a security marking or a security characteristic of the security document SD.

This first embodiment is schematically illustrated in FIG. 4. FIG. 4 shows an RFID inlay or substrate 11 of the security document SD according to the present invention. The dashed line 16a in FIG. 4 illustrates the (fictive) border of the window in which a portion of the antenna loop or winding(s) is located/visible.

Alternatively or additionally, the transparent window 2 includes a portion of an antenna as well as a part of or all of the chip or chip module 17. The dashed line 16a′ in FIG. 4 illustrates the (fictive) border of a window 2 or a second window in which a portion of the antenna loop and the chip 17 is located/visible.

In FIG. 4, the antenna 18 illustrated is a loop antenna comprising a plurality of loops formed by a continuous conductive path. This path can be for example formed by a conductive wire, by an etched deposited metal layer or by printed conductive ink as known from the art. The antenna can have the form of a continuous spiral, with a bridge portion to reconnect the external end of the spiral to the chip 17. To facilitate the comprehension of the present invention, these details are not illustrated in FIG. 4 (and FIG. 5) wherein the antenna is figuratively represented by concentric rectangles.

FIG. 4 illustrates an embodiment wherein a classical loop antenna design is used and wherein one of the plurality of transparent windows (illustrated by dotted lines 16a and 16a′) is positioned relative to a portion of the antenna in order to have antenna portions being visible in the transparent window(s).

FIG. 5 shows another preferred embodiment of the present invention, wherein the visible antenna portion shows or comprises a specific design. This specific design is distinctively different to the symmetric antenna loop or antenna perimeter windings. It could be for example forming meanders, or comprise portions of the windings deviating to be non-parallel to the others.

This specific design is formed by a portion of the antenna that deviates or extends from the principal antenna 18 to trace a marking or signature different to a marking or signature traced by the principal antenna 18. This portion of the antenna can alternatively be said to be affixed or grafted to the principal antenna 18.

More specifically, and as illustrated in FIG. 5, one can for example define a design corresponding more or less to the contour of the transparent window and forms therefore an art of additional frame. A potential resulting optical or visual effect is illustrated in FIG. 7.

The antenna 18 includes a principal antenna portion 18a and an additional antenna security segment 18b directly connected to the principal antenna portion 18a.

The additional antenna security segment 18b interrupts a principal antenna arrangement or pattern defined by the principal antenna portion 18a.

The principal antenna portion 18a is configured to receive electromagnetic radiation. And the additional antenna security segment 18b may also be configured to receive electromagnetic radiation.

The principal antenna portion 18a extends along the layer or substrate 11 to define a principle antenna pattern or arrangement. The principle antenna pattern or arrangement is a substantially rectangular loop in the exemplary embodiment illustrated in FIG. 5. This illustrated principle antenna arrangement is exemplary and can define other forms such as, for example, a spiral, circle or oval form.

This principle antenna arrangement can for example be a substantially symmetric arrangement. For example, it has reflectional symmetry, rotational symmetry, helical or spiral symmetry. For example, in FIG. 5, the principal antenna portion 18a is symmetric about central axes X or Y when the additional antenna security segment 18b is not taken into consideration.

The additional segment 18b is an interruption of the principal antenna portion 18a that is affixed or grafted to the principal antenna portion 18a.

The additional segment 18b is connected to the principal antenna portion 18a to discontinue the principle antenna arrangement or pattern. As can be seen in FIG. 5, the substantially rectangular arrangement is interrupted at section 16a and at which location the additional segment 18b is included.

The additional segment 18b is directly in physical contact with the principal antenna portion 18a.

The additional segment 18b extends from the principal antenna portion 18a to define a marking or signature (or second arrangement or pattern) different or distinct to the arrangement or pattern of the principal antenna portion 18a.

The additional segment 18b extends from the principal antenna portion 18a at an interconnection zone or location INC between additional segment 18b and the principal antenna portion 18a (see for example FIG. 5). The additional antenna security segment 18b is directly connected to the principal antenna portion 18a at each interconnection zone INC.

The arrangement or pattern of the additional segment 18b can, for example, also be a substantially symmetric arrangement. For example, it has reflectional symmetry, rotational symmetry, helical or spiral symmetry. For example, in FIG. 5, the additional segment 18b is symmetric about the central axe X.

Both the principle antenna arrangement and the arrangement of the additional segment 18b can for example be a substantially symmetric arrangement. For example, they have one of the following symmetries or both have one of the following symmetries: reflectional symmetry, rotational symmetry, helical or spiral symmetry. For example, in FIG. 5, both are symmetric about the central axe X.

However, it is not necessary that either or both the additional segment 18b and the principal antenna portion 18a comprise symmetric arrangements. One or both of these arrangements can be asymmetric.

More generally, the invention concerns a security document SD including the first arrangement or pattern defined by the principal antenna portion 18a, and the second arrangement or pattern defined by the additional segment 18b where the first and second arrangements are distinct or different from one another and the second arrangement or pattern is included in the window 2 of the security document SD.

The interconnection zone INC defines the location at which the first arrangement or pattern defined by the principal antenna portion 18a ends and at which the second arrangement or pattern defined by the additional segment 18b begins thus permitting a comparison of these two arrangements. As can be seen in FIG. 5 for example, these two arrangements are distinct and different, the second arrangement or pattern defining an open U-shaped arrangement and the first arrangement or pattern defining a substantially closed U-shaped arrangement.

Distinct or different, for example, means that he shape or form defined by the entire second antenna arrangement or pattern is not a subset of the first antenna arrangement or pattern, and/or that the shape or form defined by the entire first antenna arrangement or pattern is not a subset of the second antenna arrangement or pattern. For example, in FIG. 5, the entire second arrangement or pattern defines an open U-shaped arrangement that does not match any portion of the first arrangement that defines a substantially closed U-shaped arrangement. Additionally, the entire first arrangement or pattern defines a dosed U-shaped arrangement that does not match any portion of the second arrangement that defines a substantially open U-shaped arrangement.

This distinct and additional second arrangement advantageously permits to provide a security document that is difficult to fraudulently copy because any such copying necessitates reproducing a security marking having a particular antenna design or layout and such reproduction requires access to advanced technical capabilities for handling and manipulating antennas for RFID functionality, while at the same time does not significantly increase the manufacturing complexity of such documents.

The window 2 of the security document SD can include both the second arrangement or pattern and a portion of the first arrangement or pattern. Alternatively, the window 2 of the security document SD does not include the first arrangement or pattern and only the second arrangement or pattern and a portion. In other words, of the two arrangements, the security document SD only includes the second arrangement or pattern. The window 2 can in addition include other security features, for example, an image of the assignee of the document SD as illustrated in FIGS. 7 and 8.

FIG. 6 shows another exemplary and alternative embodiment of the present invention, wherein the antenna 18 is a UHF patch antenna extending on a large part of the substrate 11. Such a patch antenna 18 comprises a slot 19 whose position, form and design define the resonant frequency of the antenna (and define the above mentioned first arrangement or pattern). The chip or chip module 17 is positioned over the slot and connected to the parts of the antenna on each side of the slot respectively. In this particular case, the slot has been designed to include and extend to define a form in the zone 16a which correspond to letters or a logo, and which form the security feature visible in the transparent window 2 (and define the above mentioned second arrangement or pattern). The specific design forming the security feature is formed by the slot extending along the antenna to trace a marking or signature.

The UHF antenna shows a lot of degree of liberty in regards of the exact design of the antenna. This is not only restricted to the form of the antenna, but also to the materials used, and in particular their colours. In the case of a printed antenna, one can even for example use different conductive inks of different colours and create a very impressive security image, being a full part of the antenna and at least partially visible in the transparent window 2.

In a further embodiment, the transparent window 2 further includes an additional security feature or element juxtaposed or combined with the antenna portion described in any of the above embodiments.

The additional security feature includes a marking such as an image, or personal or professional data. For example, an image of the security document user 3 may be juxtaposed or combined with an antenna portion defining a framing or frame structure as illustrated for example in FIGS. 7 and 8. This additional security feature can be produced using for example laser engraving on a partially of fully transparent film located in the window 2.

The additional security feature can also be formed via printing or marking.

The combination of this additional security feature with the antenna portion where the additional security feature is at least partially touching the additional security feature provides a security document that is even more difficult to counterfeit.

Moreover, the antenna may include one or a plurality of different colours in order to make the security document even more difficult to counterfeit.

The additional security feature may be, for example, personal or professional data combined or juxtaposed with the antenna portion defining a word or a logo positioned inside the window (FIG. 6). The above mentioned user image may also be included.

The design or layout of the antenna can be used as background artwork overlapping, for example, fine lines produced by laser engraving to create a visual security feature.

The antenna portion layout as well as the above mentioned combination can provide unique and personalized security features.

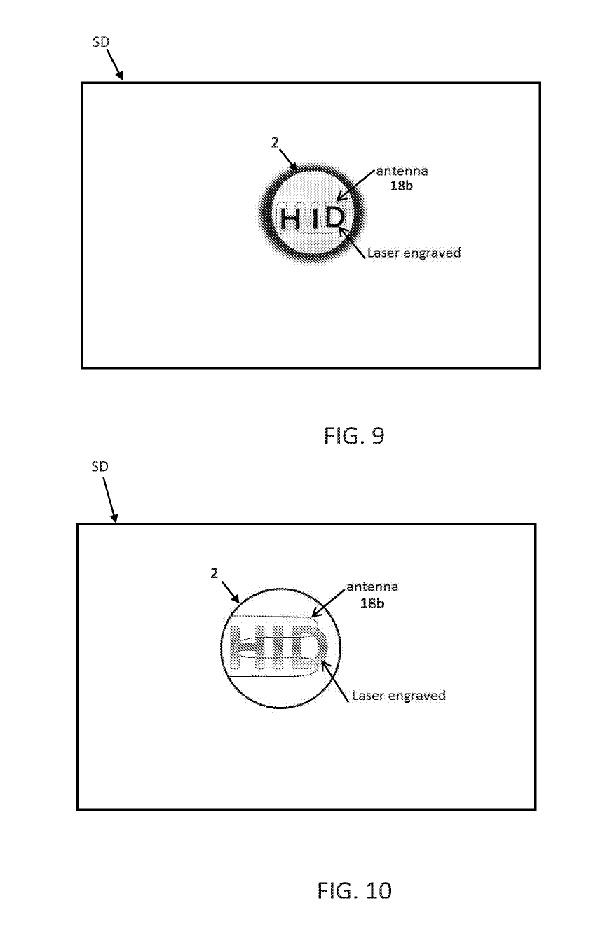

FIGS. 9 and 10 show further security documents according to the present invention. FIGS. 9 and 10 illustrate the interact action between the antenna 18 and other elements on the security documents, for example, provided via printed and/or laser engraved elements.

These elements are added after that the card has been manufactured or assembled and can thus be added to a part or layer of the security document that is different to that containing or holding the antenna 18 (for example, a different layer to layer 11).

In FIGS. 9 and 10, these elements are included using laser engraving of one of the plastic layers, for example, layers 13, 13′ (see for example FIG. 3).

The visible antenna part 18b in the window 2 has a dedicated form, and the exact position of the antenna portion 18b in the window 2 is defined before carrying out processing and the laser engraving step.

Then, a laser engraving processor takes the positioning of the antenna portion 18b into account and accordingly modifies the graphic elements to be engraved to create an appropriate visible interaction between the antenna portion 18b and the graphic elements, as can be seen for example in FIGS. 9 and 10.

In FIG. 9, the graphic elements are repositioned and eventually resized such as to be well positioned/centered in corresponding spaces or voids delimited by the antenna portion 18b and without contacting the antenna portion 18b.

In FIG. 10, appropriate cut-outs or blank zones are created in the graphical elements so as to match perfectly the positions wherein the antenna portion 18b and the graphical elements would have been overlapped or positioned one over each other.

For an observer, this provide also a graphical or artistic 3D effect produced by the provision of graphic elements in a first layer of the security document SD and the antenna portion 18b in a second different layer. Advantageously, this further secures this document against counterfeiting which becomes extremely difficult to counterfeit, for example, via a pure printing process.

Advantageously, this antenna path layout customization can be done project by project, customer by customer in order to provide a unique security feature that facilitates the authentication of the security document and/or identification of the security document user.

In another embodiment of the present invention, the material used to create the antenna in any of the above described embodiments, includes a coating. For example, the antenna wiring includes a partial or complete coating. The coating, for example, is a colour coating or a light emitting coating such as a photo luminescent coating/fluorescent coating. The coating can alternatively include both of these.

This further secures the card against counterfeiting. When used in combination with the above mentioned graphical elements, this provides an additional interactive effect with the other elements on the card.

The antenna and antenna portion can be a wire antenna, a patch antenna, a printed antenna or an etched antenna.

Advantageously, the security document of the present invention is difficult to fraudulently copy because any such copying necessitates reproducing a security marking that includes a particular antenna design or layout and requires advanced technical capabilities able to handle and manipulate antennas for RFID functionality. At the same time, it does not significantly increase the manufacturing complexity of such documents.

Having described now the preferred embodiments of this invention, it will be apparent to one of skill in the art that other embodiments incorporating its concept may be used. This invention should not be limited to the disclosed embodiments, but rather should be limited only by the scope of the appended claims.

1.-15. (canceled)

16. A security document comprising:
a. a substrate having a first side and a second side;
b. an antenna disposed on the substrate, the antenna comprising a plurality of windings between a first end and a second end, the plurality of windings comprising a first portion and a second portion, the plurality of windings of the first portion having a different shape than the shape of the plurality of windings of the second portion;
c. an integrated circuit chip disposed on the substrate and connected to both the first and second ends of the antenna; and
d. a first layer disposed over and affixed to the first side of the substrate, the first layer having a first transparent window;
e. wherein the first transparent window is aligned with the second portion of the antenna such that the second portion of the antenna is visible thereby forming a security feature.

17. The security document of claim 16 wherein a portion of the first portion of the antenna is visible through the first transparent window.

18. The security document of claim 16, further comprising a first image disposed on the substrate and wherein the first image is visible through the first transparent window.

19. The security document of claim 18, wherein the second portion of the antenna forms a portion of the first image.

20. The security document of claim 18, wherein the first image comprises one or more words.

21. The security document of claim 16, wherein at least one color or light emitting coating covers at least a portion of the plurality of the windings of the second portion of the antenna.

22. The security document of claim 16, wherein the antenna comprises one of an embedded wire, a conductive ink or a deposited metal.

23. The security document of claim 16, further comprising a visible feature laser engraved on the first transparent window, wherein the feature is at least one of an image, word and symbol.

24. The security document of claim 23, wherein the second portion of the antenna and the laser engraved feature combine to create a single visible security feature.

25. The security document of claim 16, wherein the shape of the second portion of the antenna corresponds to the shape of the first transparent window.

26. The security document of claim 16, wherein the antenna operates at one of a low frequency between 20 and 200 KHz or a high frequency between 3 and 30 MHz.

27. The security document of claim 16, further comprising a second layer disposed over and affixed to the second side of the substrate, the second layer having a second transparent window, wherein the second transparent window is aligned with the second portion of the antenna such that the second portion of the antenna is visible thereby forming a security feature.

28. The security document of claim 16, wherein the substrate comprises a rectangular shape defining a first axis extending along the centerline of the longer dimension and a second axis extending along the centerline of the shorter dimension, and wherein the first portion of the antenna is symmetric about both the first and second axes and the second portion of the antenna is asymmetrical about at least one of the first and second axes.

29. The security document of claim 16, wherein the substrate comprises a rectangular shape defining a first axis extending along the centerline of the longer dimension and a second axis extending along the centerline of the shorter dimension, and wherein both the first portion and the second portion of the antenna are symmetrical about at least one of the first and second axes.

30. The security document of claim 16, wherein the substrate comprises a rectangular shape defining a first axis extending along the centerline of the longer dimension and a second axis extending along the centerline of the shorter dimension, and wherein both the first portion and the second portion of the antenna are asymmetrical about at least one of the first and second axes.

31. A security document comprising:
a. a substrate having a first side and a second side;
b. a patch antenna disposed on at least one side of the substrate, the patch antenna having a slot formed therein;
c. an integrated circuit chip having a first contact in electrical communication with a first portion of the patch antenna and a second contact in electrical communication with a second portion of the patch antenna;
d. a first layer disposed over and affixed to the substrate with the patch antenna positioned between the first layer and the substrate, the first layer having a transparent window;
e. wherein the first transparent window is aligned with at least a portion of the slot such that at least a portion of the slot is visible thereby forming a security feature.

32. The security document of claim 31 wherein the slot forms at least one of a logo or a word aligned with the first transparent window.

33. The security document of claim 32, wherein the logo and the chip are aligned with the first transparent window.

34. A security document comprising:
a substrate having a first side and a second side;
an antenna disposed on the substrate, the antenna comprising a plurality of windings between a first end and a second end, the plurality of windings comprising a first portion and a second portion, the plurality of windings of the second portion comprising a specific design different from the first portion;
an integrated circuit chip disposed on the substrate and connected to both the first and second ends of the antenna; and
a first layer disposed over and affixed to the first side of the substrate, the first layer having a first transparent window;
wherein the first transparent window is aligned with the second portion of the antenna such that the second portion of the antenna is visible thereby forming a security feature.

35. The security document of claim 34, wherein the specific design comprising the second portion of the antenna is at least one of a logo, a word, or a frame positioned adjacent a second security feature.
